(19) United States
(12) Patent Application Publication
(10) Pub. No.: US 2011/0031808 A1
(43) Pub. Date: Feb. 10, 2011

(54) APPARATUS AND METHOD FOR DETERMINING TYPE OF ACCESSORY IN A PORTABLE TERMINAL

(75) Inventor: Jung-Eun HWANG, Seongnam-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/850,898

(22) Filed: Aug. 5, 2010

(30) Foreign Application Priority Data
Aug. 5, 2009 (KR) 10-2009-0071885

(51) Int. Cl. H02J 5/00

(52) U.S. Cl. 307/39

(57) ABSTRACT

An apparatus and method for determining the type of accessory connected to an earphone terminal in a portable terminal are provided. The apparatus includes a switching unit for controlling a power source supply time for an operation of an Analog to Digital Converter (ADC) via a power source independent of a power source supplying power to the ADC for other operations.

### PRIORITY

This application claims the benefit under 35 U.S.C. §119(a) of a Korean patent application entitled filed in the Korean Intellectual Property Office on Aug. 5, 2009 and assigned Serial No. 10-2009-0071885, the entire disclosure of which is hereby incorporated by reference.

### BACKGROUND OF THE INVENTION

1. Field of the Invention

The present invention relates to an apparatus and method for determining the type of an accessory connected to an earphone terminal in a portable terminal. More particularly, the present invention relates to an apparatus and method for, supplying a power source of an Analog-to-Digital Converter (ADC) for determining the type of accessory connected to an earphone terminal only when an accessory is connected, thus reducing the power consumption of the portable terminal.

2. Description of the Related Art

In recent years, portable terminals are gaining popularity due to their convenience. Portable terminal manufacturers are competitively developing portable terminals with more convenient functions to secure additional users. For example, the portable terminals may provide functions of phone books, games, schedulers, Short Message Services (SMS), Multimedia Message Services (MMS), Broadcast Message Services (BMS), Internet services, electronic mail (e-mail) messages, morning wakeup calls, MPEG-1 Audio Layer 3 (MP3) players, digital cameras, and the like.

Recently, the portable terminals are supporting a supplementary function through connection of an accessory (e.g., a television (TV) output cable, a Bluetooth adaptor, and the like.). In one example, the portable terminal can connect with a TV output cable and output data through a large screen of a TV set instead of a screen of the portable terminal. If a user connects a Bluetooth device to a portable terminal not supporting a Bluetooth function to listen to music data, the user can listen to the music data using the Bluetooth function instead of the portable terminal.

In the portable terminal supporting the supplementary function, when an accessory is connected to an earphone terminal, the portable terminal digital converts a signal generated according to the accessory connection and determines the type of the connected accessory. The portable terminal determines the type of accessory depending on a range of the digital converted signal. In order to enable an ADC block determining the type of accessory, the portable terminal makes use of a permanent power source of an audio block. This induces unnecessary power consumption. Even when no accessory is connected, the portable terminal makes unnecessary use of a power source for determining the type of accessory.

In addition, because the portable terminal makes use of a fixed resistance value connected to the power source for the sake of microphone (MIC) performance, a range of an ADC value corresponding to the type of accessory connected to an earphone terminal is limited. Since the range of the ADC value corresponding to the accessory connected to the portable terminal is narrow, the portable terminal can distinguish only a limited number of accessories.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for reducing the power consumption of a portable terminal.

Another aspect of the present invention is to provide an apparatus and method for controlling a time of supply of a power source of an ADC block determining the type of accessory connected to an earphone terminal in a portable terminal, thus reducing the power consumption of the portable terminal.

A further aspect of the present invention is to provide an apparatus and method for making use of a power source of an ADC block determining the type of accessory connected to an earphone terminal, as an independent power source, to expand a range of an ADC value, thus enabling a support of a plurality of accessories in a portable terminal.

The above aspects are achieved by providing an apparatus and method for determining the type of accessory in a portable terminal.

In accordance with an aspect of the present invention, an apparatus for determining the type of accessory in a portable terminal is provided. The apparatus includes a switching unit for controlling a power source supply time for an operation of an Analog-to-Digital Converter (ADC) via a power source independent of a power source supplying power to the ADC for other operations.

In accordance with another aspect of the present invention, a method for determining the type of accessory in a portable terminal is provided. The method includes controlling a power source supply time for an operation of an Analog-to-Digital Converter (ADC) via a power source independent of a power source supplying power to the ADC for other operations of the ADC.

In accordance with another aspect of the present invention, a portable terminal is provided. The portable terminal includes an earphone port for connecting an accessory to the portable terminal, an Analog-to-Digital Converter (ADC) for determining a type of the accessory connected to the earphone port, and a switching unit for supplying power to the ADC via an independent power source not used for other operations only while the ADC is determining the type of the accessory.

In accordance with another aspect of the present invention, a method of determining a type of an accessory attached to a portable terminal is provided. The method includes attaching an accessory to a portable terminal, supplying power to an Analog-to-Digital Converter (ADC) via a power source independent of a power source used for other operations of the portable terminal, determining a type of the accessory via the ADC, and stopping the supply of the power to the ADC after the type of the accessory is determined.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a construction of a portable terminal performing a switching process of an accessory connection terminal according to an exemplary embodiment of the present invention;

FIG. 2 is a flow diagram illustrating a switching process of an accessory connection terminal in a portable terminal according to an exemplary embodiment of the present invention;

FIG. 3A is a diagram illustrating conditions before connecting an accessory to a portable terminal according to an exemplary embodiment of the present invention; and

FIG. 3B is a diagram illustrating conditions after connecting an accessory to a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for controlling a time of supply of a power source of an Analog-to-Digital Converter (ADC) block determining the type of accessory connected to an earphone terminal in a portable terminal, thus reducing the power consumption of the portable terminal. The portable terminal may also employ a power source of an ADC block as an independent power source to expand a range of an ADC value, thus enabling support for a plurality of accessories. In the following description, an accessory, which operates in connection with the portable terminal, may be an external device such as an earphone, a headset, and the like, or a cable such as a television (TV) output cable for connecting the portable terminal with the external device.

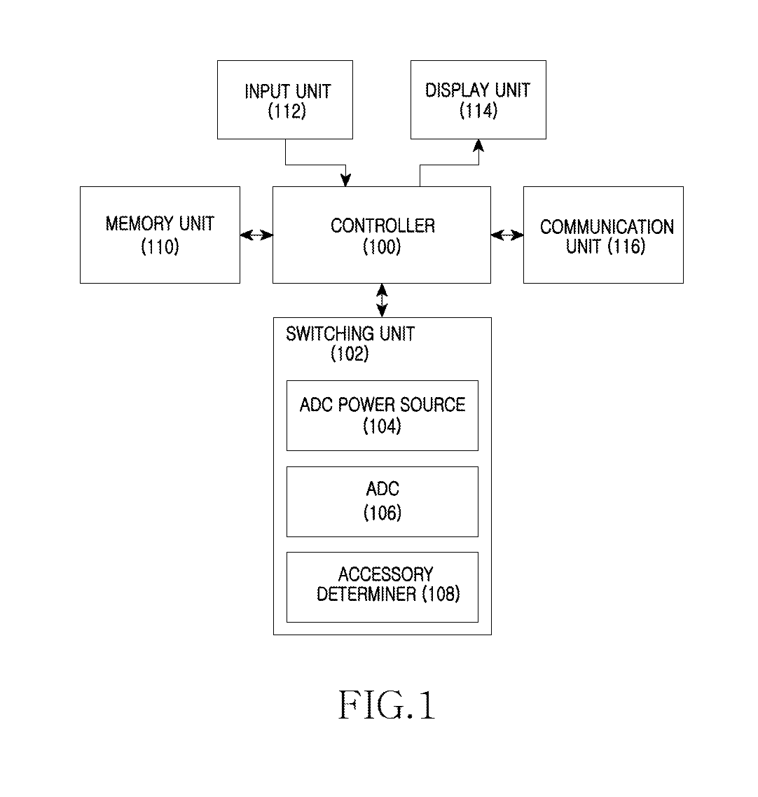

FIG. 1 is a block diagram illustrating a construction of a portable terminal performing a switching process of an accessory connection terminal according to an exemplary embodiment of the present invention.

Referring to FIG. 1, the portable terminal may include a controller 100, a switching unit 102, a memory unit 110, an input unit 112, a display unit 114, and a communication unit 116. The switching unit 102 may further include an ADC power source 104, an ADC 106, and an accessory determiner 108. The portable terminal may include additional units. Similarly, the functionality of two or more of the above units may be integrated into a single component. The portable terminal also includes an earphone terminal (not shown) having an earphone port to which an accessory may be connected.

The controller 100 of the portable terminal controls general operations of the portable terminal. For example, the controller 100 performs processing and control for voice telephony, data communication, and other applications. According to an exemplary embodiment of the present invention, when the controller 100 determines that a separate accessory is connected to the earphone terminal, the controller 100 enables the ADC power source 104 of the switching unit 102 and determines the type of accessory connected to the earphone terminal. The controller 100 switches a switch connected with the earphone terminal to a terminal corresponding to the determined type of accessory.

In order to reduce the power consumption of the portable terminal, the controller 100 enables the ADC power source 104 to the ADC 106 only when that an accessory is connected to the earphone terminal, and disable the ADC power source 104 in case that the accessory is not connected to the earphone terminal. The ADC power source may be a separate power source (not shown) that is independent of an audio block power source that supplies power to the ADC for other operations.

The controller 100 may employ a variable resistance value, not a fixed resistance value connected to a power source for an existing ADC operation, using the ADC power source 104, and expands an ADC range, thus enabling the use of a plurality of accessories.

Under the control of the controller 100, the switching unit 102 performs a switching process of reducing the power consumption of the portable terminal according to an exemplary embodiment of the present invention and a switching process of enabling the use of a plurality of accessories. In order to reduce the power consumption of the portable terminal under instructions of the controller 100, the switching unit 102 enables the ADC power source 104 only when an accessory is connected to the earphone terminal and disables the ADC power source 104 when the accessory is not connected.

The switching unit 102 allows the use of a variable resistance value, not a fixed resistance value connected to a power source for the sake of an existing ADC operation (i.e., a fixed resistance value connected between an audio block and a microphone (MIC) power source for the sake of a normal operation of a MIC), using the ADC power source 104, thus being capable of expanding an ADC range. This makes the use of a plurality of accessories possible.

The ADC power source 104 of the switching unit 102 supplies a power source to the ADC 106 to determine the type of the connected accessory. The ADC power source 104 does not supply a power source to the ADC 106 before an accessory is connected to the portable terminal.

Under the control of the switching unit 102, the ADC 106 converts an analog signal generated according to the accessory connection into a digital signal and provides the digital signal to the accessory determiner 108. The accessory determiner 108 determines the type of accessory connected to the portable terminal using an ADC value received from the ADC 106. The accessory determiner 108 determines if the ADC value received from the ADC 106 corresponds to a range of a previously stored ADC value. If so, the accessory determiner 108 determines that an accessory corresponding to the range including the previously stored ADC values is connected with the portable terminal.

The memory unit 110 includes a Read Only Memory (ROM), a Random Access Memory (RAM), a flash ROM, and the like. The ROM stores a microcode (i.e., code) of a program for processing and controlling the controller 100 and the switching unit 102 and a variety of kinds of reference data. The RAM, a working memory of the controller 100, stores temporary data generated in execution of a variety of kinds of programs. The flash ROM stores several kinds of updateable depository data such as a phone book, an outgoing message, an incoming message, and information on a user's touch input point.

The input unit 112 includes numeral key buttons ‘0 ’ to ‘9 ’, a menu button, a cancel button, an OK button, a talk button, an end button, an Internet button, navigation key (or direction key) buttons, a plurality of function keys such as a character input key, and the like. The input unit 112 provides key input data corresponding to a key pressed by a user to the controller 100. These keys are merely examples of keys which may make up the input unit 112; the input unit may include additional or different keys, or different input mechanisms through which the user supplies input to the portable terminal.

The display unit 114 displays state information generated during operation of the portable terminal, a limited number of characters, moving pictures, still pictures, and the like. The display unit 114 can be a color Liquid Crystal Display (LCD), an Active Mode Organic Light Emitting Diode (AMOLED), and the like. The display unit 114 can include a touch input device and when applied to a portable terminal of a touch input scheme, can be used as the input unit 112.

The communication unit 116 transmits, receives, and processes a radio or other wireless signal through an antenna (not illustrated). For example, in a transmission mode, the communication unit 116 processes original data through channel coding and spreading, converts the original data into a Radio Frequency (RF) signal, and transmits the RF signal. In a reception mode, the communication unit 116 converts a received RF signal into a baseband signal, processes the baseband signal through de-spreading and channel decoding, and restores the signal to original data.

The portable terminal may include a terminal (not illustrated) connectable with a plurality of accessories, such as an earphone terminal or accessory-specific terminal. Furthermore, a role of the switching unit 102 can be implemented by the controller 100 of the portable terminal. However, these are separately constructed and shown herein as an exemplary construction for convenience of description, and do not limit the scope of the present invention. It would be understood by those skilled in the art that various modifications can be made within the scope of the present invention. For example, construction can also be such that all of them are processed in the controller 100.

The above description is made for an apparatus for supplying a power source of an ADC for determining the type of accessory connected to an earphone terminal in a portable terminal only when the accessory is connected, according to an exemplary embodiment of the present invention, thereby reducing the power consumption of the portable terminal and enabling a support of a plurality of accessories. The following description is made for a method for reducing the power consumption of a portable terminal and enabling a support of a plurality of accessories, according to the exemplary embodiment of the present invention.

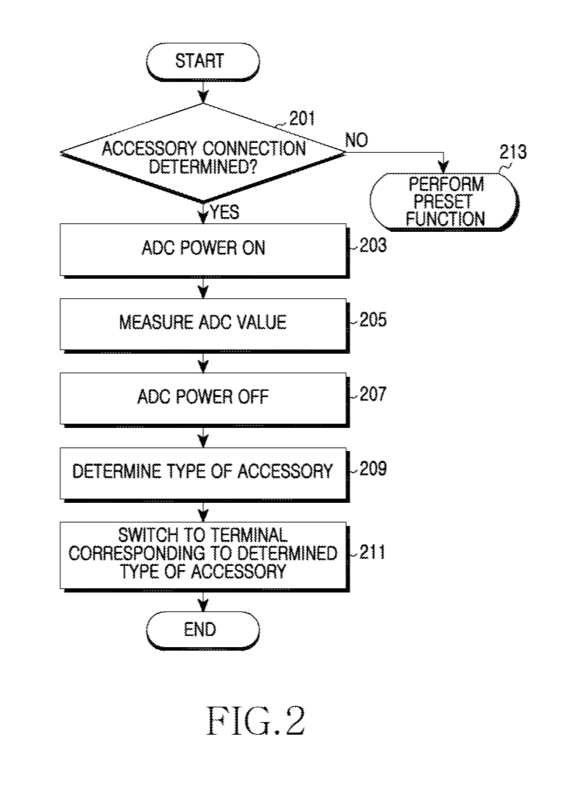

FIG. 2 is a flow diagram illustrating a switching process of an accessory connection terminal in a portable terminal according to an exemplary embodiment of the present invention.

Referring to FIG. 2, in step 201, the portable terminal determines if an accessory is connected to the portable terminal. Connecting the accessory refers to connecting an accessory, such as a TV output cable, a headset, and the like, to an earphone terminal of the portable terminal.

If it is determined that the accessory is not connected in step 201, the portable terminal proceeds to step 213 and performs a corresponding function (e.g., a standby mode). If it is determined that the accessory is connected in step 201, the portable terminal proceeds to step 203 and enables an ADC power source 104 of a switching unit 102 to supply a power source to the ADC 106 for ADC converting a signal generated according to the accessory connection. In step 205, the portable terminal proceeds to step 205 and enables the ADC 106 using the power source received from the ADC power source 104 and measures an ADC value of the signal generated according to the accessory connection.

Unlike a conventional portable terminal, which always supplies a power source to an ADC using a permanent power source of an audio block, the portable terminal according to an exemplary embodiment of the present invention enables the ADC power source 104 only after an accessory is connected to the portable terminal, and reduces the power consumption of the portable terminal.

After supplying the power source and measuring the ADC value of the signal generated according to the accessory connection, the portable terminal proceeds to step 207 and disables the ADC power source 104. In step 209, the portable terminal controls the accessory determiner 108 to determine the type of accessory connected with the portable terminal using the measured ADC value of step 205. The portable terminal can make use of the independent ADC power source to expand an ADC range of the portable terminal and support a plurality of accessories according to an exemplary embodiment of the present invention.

A portable terminal according to exemplary embodiments of the present invention makes use of an independent power source to enable a resistance control for ADC voltage control irrespective of the performance of a MIC and expand a range of an ADC value for a support of various accessories, whereas a conventional portable terminal employs a fixed resistance between an audio block and a MIC power source for the sake of a normal operation of a MIC so as to determine connection of an accessory using the MIC power source of the audio block.

In step 211, the portable terminal proceeds to step 211 and switches to a terminal corresponding to the type of accessory determined in step 209, performing a corresponding operation. The portable terminal according to exemplary embodiments of the present invention can supply an ADC power source for determining the type of accessory only when connecting an accessory to prevent the power consumption of the portable terminal, and make use of a separate ADC power source to expand a range of an ADC value through a resistance control for ADC voltage control and support a plurality of accessories.

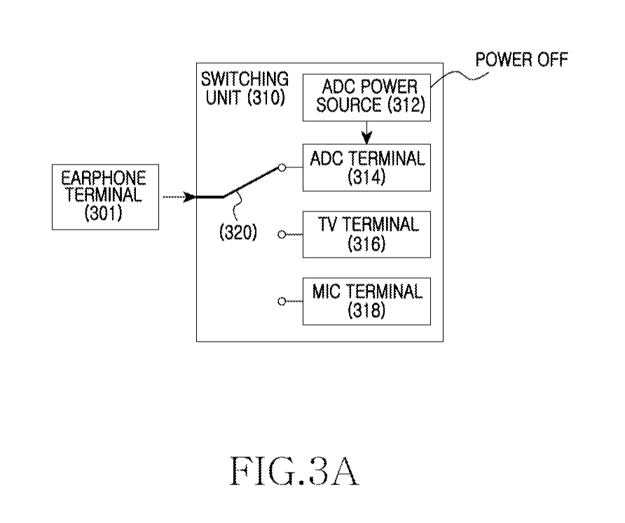

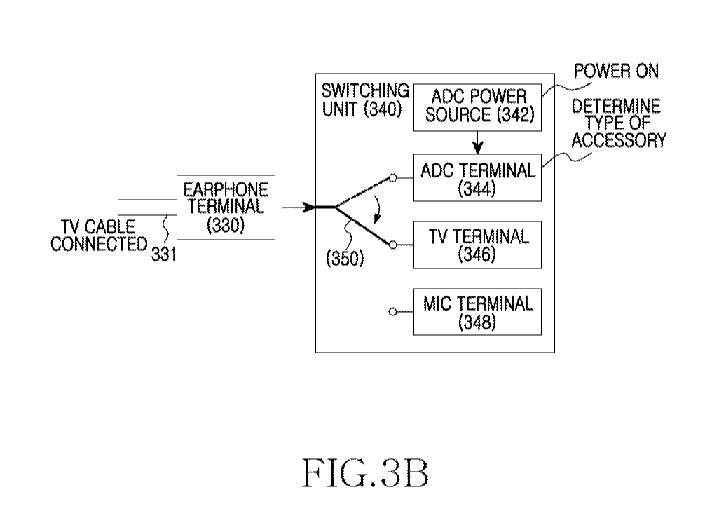

FIGS. 3A and 3B are diagrams illustrating a switching process of an accessory connection terminal in a portable terminal according to an exemplary embodiment of the present invention.

FIG. 3A is a diagram illustrating conditions before connecting an accessory to a portable terminal according to an exemplary embodiment of the present invention.

Referring to FIG. 3A, the portable terminal according to an exemplary embodiment of the present invention makes use of an ADC terminal 314 separating various accessory terminals (e.g., a TV terminal 316, a MIC terminal 318, and the like), and makes use of an ADC power source 312 that is a separate independent power source. Until an accessory is connected to an earphone terminal 301 of the portable terminal, a switching unit 310 maintains the ADC power source 312 in a powered off state such that a switch 310 connects the earphone terminal 301 to the ADC terminal 314. When an accessory is connected to the earphone terminal 301 of the portable terminal, the switching unit 310 releases the connection of the ADC terminal 314 to reduce the power consumption of the portable terminal.

By not determining connection of an accessory using a MIC power source of an audio block but enabling a control of a resistance value for ADC voltage control irrespective of the performance of a MIC using the separate ADC power source 312 as described above, the portable terminal according to exemplary embodiments of the present invention can expand an ADC range for a support of a plurality of accessories.

When the accessory is connected to the earphone terminal 301 of the portable terminal, the portable terminal enables the ADC power source 312 to supply a power source to the ADC terminal 314, and determines the type of accessory connected to the earphone terminal 301, and switches to a terminal corresponding to the determined type of accessory. For example, when the portable terminal determines that a TV output cable is connected to the earphone terminal 301, the portable terminal switches to the TV terminal 316 from the ADC terminal 314. Similarly, when the portable terminal determines that a MIC is connected to the earphone terminal 301, the portable terminal switches to the MIC terminal 318 from the ADC terminal 314.

FIG. 3B is a diagram illustrating conditions after connecting an accessory to a portable terminal according to an exemplary embodiment of the present invention.

Referring to FIG. 3B, when the portable terminal determines that an accessory (e.g., a TV output cable 331) is connected to an earphone terminal 330, the portable terminal enables a disabled ADC power source 342 of a switching unit 340 to supply a power source to an ADC terminal 344. Accordingly, the portable terminal determines the type of accessory connected to the earphone terminal 330 using an ADC value of a signal, which is generated as the accessory is connected to the earphone terminal 330. As above, the portable terminal does not supply a power source to the ADC terminal 344 before the accessory is connected, and supplies the power source to the ADC terminal 344 only after the accessory is connected, thus being capable of preventing the power consumption of the portable terminal.

When the portable terminal determines that the TV output cable 331 is connected to the earphone terminal 330 using a signal generated according to the connection of the TV output cable 331, the portable terminal switches to a TV terminal 346 from the ADC terminal 344 enabled according to the accessory connection via a switch 350. When the portable terminal determines that a MIC is connected to the earphone terminal 330, the portable terminal switches to a MIC terminal 348 from the ADC terminal 344, thus reducing power consumption.

As described above, exemplary embodiments of the present invention relate to an apparatus and method for determining a type of an accessory connected to an earphone terminal in a portable terminal. Portable terminals according to exemplary embodiments of the present invention control a time of supply of a power source of an ADC block determining the type of accessory connected to an earphone terminal to reduce the power consumption of the portable terminal, and make use of a power source of an ADC block as an independent power source to expand a range of an ADC value, thus enabling a support of a plurality of accessories in the portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for determining the type of accessory in a portable terminal, the apparatus comprising:
a switching unit for controlling a power source supply time for an operation of an Analog-to-Digital Converter (ADC) via a power source independent of a power source supplying power to the ADC for other operations.

2. The apparatus of claim 1, wherein the switching unit further comprises:
an ADC power source for, when determining accessory connection, supplying the independent power source, determining the type of accessory, and stopping the supply of the independent power source after the type of the accessory is determined;
an ADC for ADC converting a signal generated according to the accessory connection; and
an accessory determiner for determining the type of connected accessory using the ADC-converted signal.

3. The apparatus of claim 2, wherein the switching unit comprises an ADC terminal separate from accessory terminals.

4. The apparatus of claim 3, wherein, before the accessory is connected, the switching unit maintains a connection with the ADC terminal and, after the accessory is connected, the switching unit releases the connection with the ADC terminal and switches the connection to a terminal of a corresponding accessory.

5. The apparatus of claim 2, wherein the switching unit employs the independent power source to supply a power source for an operation of an ADC and to enable a resistance value control for ADC voltage control.

6. The apparatus of claim 5, wherein the switching unit expands a range of converting a signal generated according to the accessory connection through the resistance value control for the ADC voltage control, and enables a support of a plurality of accessories.

7. The apparatus of claim 1, wherein the independent power source is independent of a MIC power source of an audio block to supply a power source for other operations of the ADC.

8. A method for determining the type of accessory in a portable terminal, the method comprising:
controlling a power source supply time for an operation of an Analog-to-Digital Converter (ADC) via a power source independent of a power source supplying power to the ADC for other operations of the ADC.

9. The method of claim 8, further comprising:
supplying the independent power source for the ADC operation when determining whether an accessory is connected to a portable terminal;
converting a signal generated according to the accessory connection into a digital signal;
determining the type of connected accessory using the converted signal; and
after determining the type of connected accessory, stopping the supplying of the independent power source for the ADC operation.

10. The method of claim 9, further comprising:
before the accessory is connected, maintaining a connection with the ADC terminal; and
after the accessory is connected, releasing the connection of the ADC terminal and switching the connection to a terminal of a corresponding accessory.

11. The method of claim 10, wherein a power source for other operations of an ADC is independent of the independent power source so as to enable a resistance value control for ADC voltage control.

12. The method of claim 8, wherein the controlling of the power source supply time for the operation of the ADC comprises controlling the power source supply time via the separate power source independent of a MIC power source of an audio block to supply a power source for the operation of the ADC.

13. A portable terminal comprising:
an earphone port for connecting an accessory to the portable terminal;
an Analog-to-Digital Converter (ADC) for determining a type of the accessory connected to the earphone port; and
a switching unit for supplying power to the ADC via an independent power source not used for other operations only while the ADC is determining the type of the accessory.

14. The portable terminal of claim 13, wherein the switching unit further comprises:
the ADC;
the independent power source; and
an accessory determination unit for determining the type of the accessory.

15. The portable terminal of claim 14, wherein the ADC further comprises:
an ADC terminal; and
at least one accessory terminal separate from the ADC, each accessory terminal corresponding to an accessory type.

16. The portable terminal of claim 15, wherein the switching unit maintains a connection between the earphone port and the ADC terminal before the accessory is connected, and switches the connection from the ADC terminal to the accessory terminal corresponding to the determined accessory type after the type of the accessory is determined.

17. A method of determining a type of an accessory attached to a portable terminal, the method comprising:
attaching an accessory to a portable terminal;
supplying power to an Analog-to-Digital Converter (ADC) via a power source independent of a power source used for other operations of the portable terminal;
determining a type of the accessory via the ADC; and
stopping the supply of the power to the ADC after the type of the accessory is determined.
